(19) United States
(12) Patent Application Publication
(10) Pub. No.: US 2017/0359284 A1
(43) Pub. Date: Dec. 14, 2017

(54) SYSTEM AND METHOD FOR REGULATING TRANSMISSION OF CONTENT TO PUBLIC PLATFORMS USING CONTEXT-BASED ANALYSIS

(71) Applicants: Barry C. Sudduth, Central, SC (US); Robert B. Hanson, Mobile, AL (US)

(72) Inventors: Barry C. Sudduth, Central, SC (US); Robert B. Hanson, Mobile, AL (US)

(21) Appl. No.: 15/617,971

(22) Filed: Jun. 8, 2017

Related U.S. Application Data
(60) Provisional application No. 62/347,473, filed on Jun. 8, 2016.

(51) Int. Cl. H04L 12/58; H04L 29/08; H04L 12/24

(52) U.S. Cl. CPC H04L 51/063; H04L 51/32; H04L 41/22; H04L 67/36; H04L 51/12; H04L 67/306

(57) ABSTRACT

A system and method for regulating transmission of content to public platforms using context-based analysis are provided. Content for publication on one or more public platforms is generated by user interaction via a user interface and subsequently submitted to a server. The server assigns submitted content to reviewers having a defined familiarity level with the user or organizations affiliated therewith. Reviewers may be assigned to one or more review groups. Reviewer acceptance or rejection of the content for publication is governed by defined context criteria. The server analyzes the reviewers' acceptance or rejection of the content against acceptance criteria defined by a system administrator. Upon determining the acceptance criteria has been satisfied, the server transmits the content to one or more public platforms for publication thereon. Failure to satisfy the acceptance criteria may result in the content being restricted to the confines of a private network.

### CROSS-REFERENCE TO RELATED APPLICATIONS

This application claims priority to U.S. Provisional Patent Application No. 62/234,473, entitled “A social media content authorization system,” filed Jun. 8, 2016, which application is incorporated herein in its entirety.

### FIELD OF THE DISCLOSURE

The subject matter of the present disclosure refers generally to a system and method for regulating transmission of content to public platforms using context-based analysis.

### BACKGROUND

Due to the communication and public outreach applications facilitated through social media platforms, such as, Facebook, Twitter, Snapchat, and Instagram, social media usage amongst individuals and organizations alike has greatly increased in recent years. Currently, social media platforms not only serve as a tool for social upkeep amongst peers, but also as a public platform in which individuals and organizations can promote their brand, market their goods and services, and target specific customers. Accordingly, the content shared by an individual or organization on social media platforms may greatly influence and shape public opinion of the individual or organization. Many times, however, individuals post inappropriate content that not only reflects poorly on themselves, but also any organizations to which the individual may be affiliated. In extreme circumstances, inappropriate content shared on social media platforms can result in disciplinary, financial, and/or legal repercussions for the individual and/or organizations implicated by or associated with the inappropriate content. Although individuals can simply refrain from publicly sharing inappropriate content, often times, individuals sharing such content do not recognize or fully appreciate that the content shared may reflect poorly on them and/or any organization to which they are affiliated. Thus, a general need exists for systems and methods providing secondary review of user-generated content submitted for display on public platforms.

Although efforts have been made in the art to restrict the display of inappropriate content on public platforms, such efforts are largely ineffective as they generally either only attempt to limit the time in which the shared content is publicly visibile or are incapable of deciphering the context of the content submitted for public display with respect to manner in which the content may negatively affect the individual or affiliated organizations. Currently, many social media platforms utilize moderators that monitor and subsequently remove content that is deemed offensive by the social media platform or are off-topic with respect to forum discussion. However, because moderators can only regulate the display of content after it has been shared publicly, any risk associated with the shared content is already assumed by the individual or organization to which the content is associated. For example, even if the content shared by an individual is removed from the social media platform within five minutes of posting, other members may memorialize the shared content by taking a screen shot or photo for later use. Additionally, moderators only serve to placate the members of the public platform as a whole. That is, moderators are generally not concerned with preventing potential blowback to specific individuals and/or organizations affiliated with the shared content. Thus, shared content that is not generally offensive is often not removed by moderators, even though such content may adversely affect the posting individual or organizations to which the individual is affiliated.

It follows, then, that the only way to truly guard against blowback from potentially damaging shared content is to prevent such content from being publicly shared in the first instance. However, systems and methods currently known in the art that attempt to review and prevent publication of inappropriate or offensive user-created content on public platforms are generally error prone and thus ineffective. Generally, systems and methods currently employed within the art primarily rely on word- or phrase-based analysis to identify inappropriate or offensive content within user-created content. Such word- or phrase-based analysis generally requires populating a reference list or dictionary with words and/or phrases that are defined as inappropriate or offensive and manually labeling or indexing them as such. To identify inappropriate words or phrases, user-created content is compared against the words and/or phrases within the reference material to determine any matches therebetween. Words or phrases within the user content matching the words or phrases defined as inappropriate or offensive are either labeled as such for subsequent user revision or the user-created content is prevented from being shared on the public platform.

However, the effectiveness of such word- or phrase-based analysis is readily undermined by creative or alternative spellings, which are not provided for within the reference list or dictionary. Even more problematic, however, is the fact that systems and methods employing such analysis are incapable of deciphering the context of the user-created content submitted for public display with respect to how the content may adversely affect the individual or affiliated organizations. That is, known systems and methods are generally incapable of identifying instances where content shared by an individual is free of offensive language but is nonetheless damaging to the individual and/or organizations affiliated with the individual based on context.

Accordingly, there is a need in the art for a system and method designed to identify user content as unsuitable or suitable for publication on public platforms based on the manner in which such content may adversely affect the individual sharing such content and/or organizations to which the individual is affiliated. Moreover, there is a need the art for a system and method that achieves this end and prevents the transmission of unsuitable content to public platforms.

### SUMMARY

A system and method for regulating the transmission of user-created content to public platforms is provided. Generally, the system and method of the present disclosure are designed to regulate user content transmitted to public platforms for public display using context-based analysis. The method of the present disclosure facilitates context-based analysis by assigning content generated by a user to one or more reviewers capable of reviewing content in the context of how the assigned content may negatively affect the user submitting the content and/or organizations affiliated with that user. Individuals approved to serve as reviewers are preferably limited those individuals having a defined familiarity level with the user and/or organizations affiliated with the user.

In a preferred embodiment, a system administrator defines a set of acceptance criteria relating to the reviewers' acceptance or rejection of the content. The reviewers' acceptance or rejection of the assigned content in relation to the acceptance criteria governs the transmission of the content to one or more public platforms selected by a user. That is, only user content that is accepted by reviewers in accordance with the guidelines established by the acceptance criteria is permitted transfer to the selected public platforms. In one preferred embodiment, the acceptance criteria may require a defined number of reviewers to accept the user content before transmission to the public platforms is permitted. Satisfaction of the acceptance criteria results in a server transmitting the user content to the public platforms selected by the user. In cases where the selected public platforms are social media platforms, the server may first transmit the user's account credentials associated with the social media platforms prior to transmitting the user content for publication. User content not qualifying for transmission to the public platforms may be confined within a private network.

To carry out the various operations disclosed above, the system of the present disclosure may comprise a first computing device, a second computing device, a database, a server, and a non-transitory computer-readable medium coupled to the server. The non-transitory computer-readable medium having instructions stored thereon, which, when executed by the server, cause the server to perform operations disclosed herein. In a preferred embodiment, the above-described components may be operably connected in a manner as to form a private network. The system may further comprise a public platform configured to receive user content transmitted from the private network.

The foregoing summary has outlined some features of the system and method of the present disclosure so that those skilled in the pertinent art may better understand the detailed description that follows. Additional features that form the subject of the claims will be described hereinafter. Those skilled in the pertinent art should appreciate that they can readily utilize these features for designing or modifying other structures for carrying out the same purpose of the system and method disclosed herein. Those skilled in the pertinent art should also realize that such equivalent designs or modifications do not depart from the scope of the system and method of the present disclosure.

### DESCRIPTION OF DRAWINGS

These and other features, aspects, and advantages of the present disclosure will become better understood with regard to the following description, appended claims, and accompanying drawings where:

FIG. 1 is a diagram of an example environment in which techniques described herein may be implemented.

FIG. 2 is an exemplary diagram of a client of FIG. 1 according to an implementation consistent with the principles of the present disclosure.

FIG. 3 is a diagram of an example computing device and mobile computing device.

FIG. 4 is a diagram illustrating a system embodying features consistent with the principles of the present disclosure.

FIG. 5 is a flowchart illustrating certain method steps of a method for regulating the transmission of content to public platforms consistent with the principles of the present disclosure.

FIG. 6 is a diagram illustrating how user content generated within a private network may be reviewed and subsequently transmitted to a public platform in a manner consistent with the principles of the present disclosure.

FIG. 7 is a flowchart illustrating certain method steps of a method for regulating the transmission of content within a private network to external public platforms consistent with the principles of the present disclosure.

FIG. 8 is a diagram illustrating the manner in which individual access to data may be limited based on user, reviewer, or administrator roles.

FIG. 9 illustrates an example user interface for users to generate content in a manner consistent with the principles of the present disclosure.

FIG. 10 illustrates an example user interface for reviewers to review user content in a manner consistent with the principles of the present disclosure.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises” and grammatical equivalents thereof are used herein to mean that other components, steps, etc. are optionally present. For example, a system “comprising” components A, B, and C can contain only components A, B, and C, or can contain not only components A, B, and C, but also one or more other components. As used herein, the term “created vector” and grammatical equivalents refers to the one or more vectors created by the processor based on the mapped activation levels of the one or more sensors.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

As will be evident from the disclosure provided below, the subject matter of the present disclosure satisfies the need for a system and method for limiting information access based on user identity verification, thereby improving upon known systems currently employed within the art.

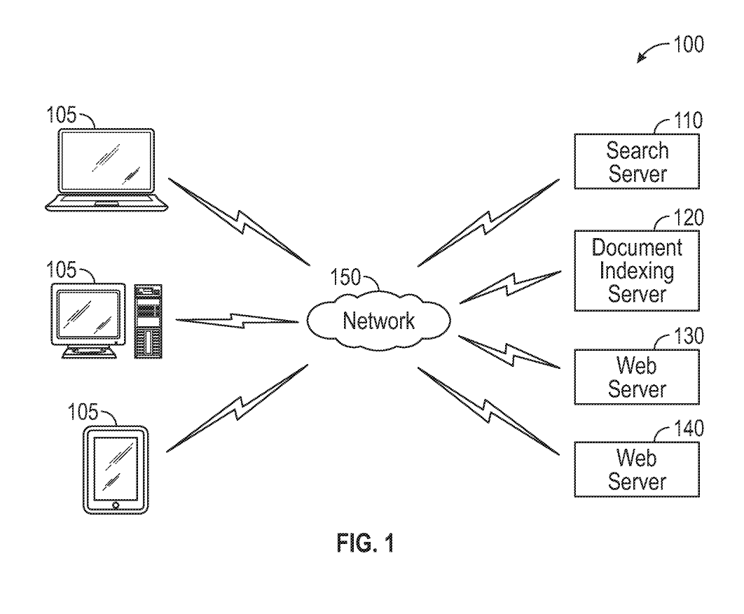

FIG. 1 is a diagram of an example environment 100 in which techniques described herein may be implemented. Environment 100 may include multiple clients 105 connected to one or more servers 110-140 via a network 150. In some implementations, and as illustrated, server 110 may be a search server, that may implement a search engine; and server 120 may be a document indexing server, e.g., a web crawler; and servers 130 and 140 may be general web servers, such as servers that provide content to clients 105. Clients 105 and servers 110-140 may be connected to network 150 via wired, wireless, or a combination of wired and wireless connections.

Three clients 105 and four servers 110-140 are illustrated as connected to network 150 for simplicity. In practice, there may be additional or fewer clients and servers. Also, in some instances, a client may perform the functions of a server and a server may perform the functions of a client.

Clients 105 may include devices of users that access servers 110-140. A client 105 may include, for instance, a personal computer, a wireless telephone, a personal digital assistant (PDA), a laptop, a smart phone, a tablet computer, or another type of computation or communication device. Servers 110-140 may include devices that access, fetch, aggregate, process, search, provide, and/or maintain documents. Although shown as single components 110, 120, 130, and 140 in FIG. 1, each server 110-140 may, in some implementations, be implemented as multiple computing devices, which potentially may be geographically distributed.

Search server 110 may include one or more computing devices designed to implement a search engine, such as a documents/records search engine, general webpage search engine, etc. Search server 110 may, for example, include one or more web servers to receive search queries and/or inputs from clients 105, search one or more databases in response to the search queries and/or inputs, and provide documents or information, relevant to the search queries and/or inputs, to clients 105. In some implementations, search server 110 may include a web search server that may provide webpages to clients 105, where a provided webpage may include a reference to a web server, such as one of web servers 130 or 140, at which the desired information and/or links is located. The references, to the web server at which the desired information is located, may be included in a frame and/or text box, or as a link to the desired information/document.

Document indexing server 120 may include one or more computing devices designed to index documents available through network 150. Document indexing server 120 may access other servers, such as web servers that host content, to index the content. In some implementations, document indexing server 120 may index documents/records stored by other servers, such as web servers 130 and 140 and, connected to network 150. Document indexing server 120 may, for example, store and index content, information, and documents relating to user accounts and user-generated content.

Web servers 130 and 140 may each include web servers that provide webpages to clients. The webpages may be, for example, HTML-based webpages. A web server 130/140 may host one or more websites. A website, as the term is used herein, may refer to a collection of related webpages. Frequently, a website may be associated with a single domain name, although some websites may potentially encompass more than one domain name. The concepts described herein may be applied on a per-website basis. Alternatively, in some implementations, the concepts described herein may be applied on a per-webpage basis.

While servers 110-140 are shown as separate entities, it may be possible for one or more servers 110-140 to perform one or more of the functions of another one or more of servers 110-140. For example, it may be possible that two or more of servers 110-140 are implemented as a single server. It may also be possible for one of servers 110-140 to be implemented as multiple, possibly distributed, computing devices.

Network 150 may include one or more networks of any kind, including, but not limited to, a local area network (LAN), a wide area network (WAN), metropolitan area networks (MAN), a telephone network, such as the Public Switched Telephone Network (PSTN), an intranet, the Internet, a memory device, another type of network, or a combination of networks.

Although FIG. 1 shows example components of environment 100, in other implementations, environment 100 may contain fewer components, different components, differently arranged components, and/or additional components than those depicted in FIG. 1. Alternatively, or additionally, one or more components of environment 100 may perform one or more other tasks described as being performed by one or more other components of environment 200.

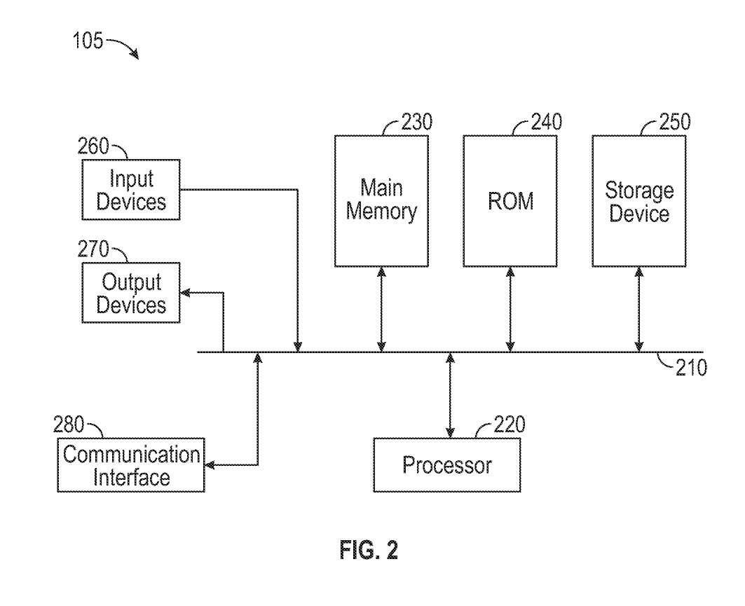

FIG. 2 is an exemplary diagram of a user/client 105 or server entity (hereinafter called “client/server entity”), which may correspond to one or more of the clients and servers, according to an implementation consistent with the principles of the invention. The client/server entity 105 may include a bus 210, a processor 220, a main memory 230, a read only memory (ROM) 240, a storage device 250, one or more input devices 260, one or more output devices 270, and a communication interface 280. Bus 210 may include one or more conductors that permit communication among the components of the client/server entity 105.

Processor 220 may include any type of conventional processor or microprocessor that interprets and executes instructions. Main memory 230 may include a random access memory (RAM) or another type of dynamic storage device that stores information and instructions for execution by processor 220. ROM 240 may include a conventional ROM device or another type of static storage device that stores static information and instructions for use by processor 220. Storage device 250 may include a magnetic and/or optical recording medium and its corresponding drive.

Input device(s) 260 may include one or more conventional mechanisms that permit an operator to input information to the client/server entity 105, such as a scanner, phone, camera, scanning device, keyboard, a mouse, a pen, voice recognition and/or biometric mechanisms, etc. Output device(s) 270 may include one or more conventional mechanisms that output information to the operator, including a display, a printer, a speaker, an alarm, a projector, etc. Communication interface 280 may include any transceiver-like mechanism that enables the client/server entity 105 to communicate with other devices 105 and/or systems. For example, communication interface 280 may include mechanisms for communicating with another device 105 or system via a network, such as network 150.

As will be described in detail below, the client/server entity 105, consistent with the principles of the invention, performs certain receiving, communicating, generating, output providing, correlating, and storing operations. The client/server entity 105 may perform these operations in response to processor 220 executing software instructions contained in a computer-readable medium, such as memory 230. A computer-readable medium may be defined as one or more physical or logical memory devices and/or carrier waves.

The software instructions may be read into memory 230 from another computer-readable medium, such as data storage device 250, or from another device via communication interface 280. Examples of computer-readable mediums include, but are not limited to, magnetic media such as hard disks, floppy disks, and magnetic tape; optical media such as CD ROM discs and DVDs; magneto-optical media such as optical discs; and hardware devices that are specially configured to store and perform programming instructions, such as read-only memory (ROM), random access memory (RAM), flash memory, and the like. The software instructions contained in memory 230 causes processor 220 to perform processes that will be described later. Alternatively, hardwired circuitry may be used in place of or in combination with software instructions to implement processes consistent with the principles of the invention. Thus, implementations consistent with the principles of the invention are not limited to any specific combination of hardware circuitry and software.

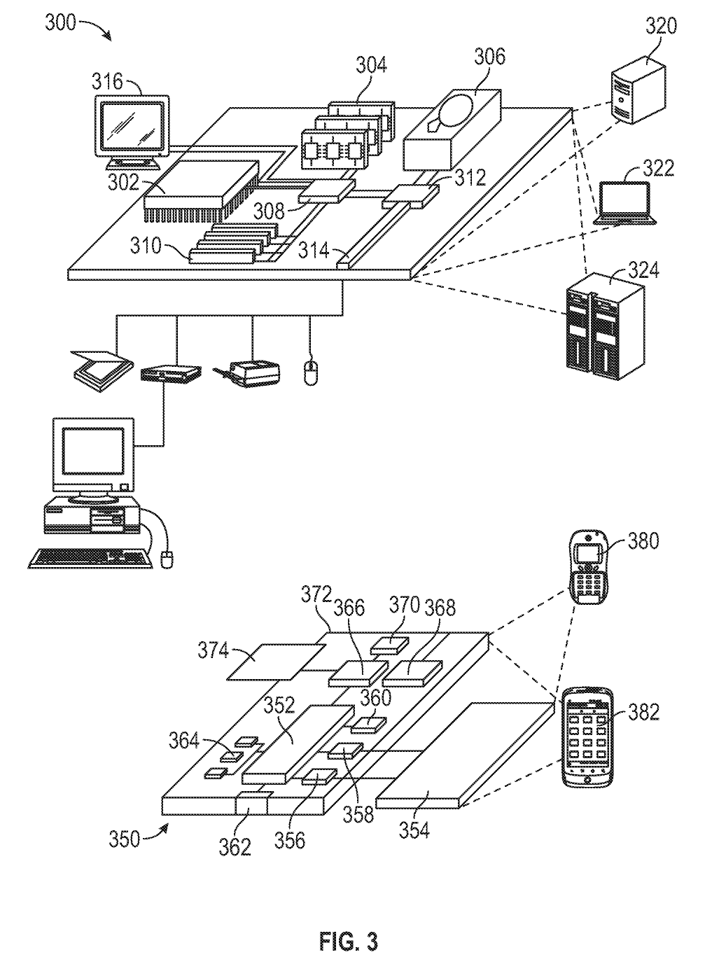

FIG. 3 is a diagram of an example of a computing device 300 and a mobile computing device 350, which may be used with the techniques described here. Computing device 300 or mobile computing device 350 may correspond to, for example, a client 205 and or a server 210-240. Computing device 300 is intended to represent various forms of digital computers, such as laptops, desktops, workstations, personal digital assistants, servers, mainframes, and other appropriate computers. Mobile computing device 350 is intended to represent various forms of mobile devices, such as scanners, scanning devices, personal digital assistants, cellular telephones, smart phones, tablet computers, and other similar computing devices. The components show in FIG. 3, their connections and relationships, and their functions, are meant to be examples only, and are not meant to limit implementations described herein.

Computing device 300 may include a processor 302, a memory 304, a storage device 306, a high-speed interface 308 connecting to a memory 304 and high-speed expansion ports 310, and a low-speed interface 312 connecting to a low-speed expansion port 314 and a storage device 306. Each of components 302, 304, 306, 308, 310, 312, and 314 are interconnected using various buses, and may be mounted on a common motherboard or in other manners as appropriate. Processor 302 can process instructions for execution within computing device 300, including instructions stored in memory 304 or on storage device 306 to display graphical information for a graphical user interface (GUI) on an external input/output device, such as display 316 coupled to high-speed interface 308. In other implementations, multiple processors and/or multiple buses may be used, as appropriate, along with multiple memories and types of memory. Also, multiple computing devices 300 may be connected, with each device providing portions of the necessary operations, as a server bank, a group of blade servers, or a multi-processor system, etc.

Memory 304 stores information within computing device 300. In some implementations, memory 304 includes a volatile memory unit or units. In another implementation, memory 304 may include a non-volatile memory unit or units. Memory 304 may also be another form of computer-readable medium, such as a magnetic or optical disk. A computer-readable medium may refer to a non-transitory memory device. A memory device may refer to storage space within a single storage device or spread across multiple storage devices.

Storage device 306 is capable of providing mass storage for computing device 300. In some implementations, storage device 306 may be or contain a computer-readable medium, such as a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described herein. The information carrier is a computer or machine-readable medium, such as memory 304, storage device 306, or a memory on processor 302.

High-speed interface 308 manages bandwidth-intensive operations for computing device 300, while low-speed interface 312 manages lower bandwidth-intensive operations. Such allocation of functions is an example only. In some implementations, high-speed interface 308 is coupled to memory 304, display 316, such as through a graphics processor or accelerator, and to high-speed expansion ports 310, which may accept various expansion cards. In this implementation, low-speed interface 312 may be coupled to storage device 306 and low-speed expansion port 314. Low-speed expansion port 314, which may include various communication ports, such as USB, Bluetooth, Ethernet, wireless Ethernet, etc., may be coupled to one or more input/output devices, such as a keyboard, a pointing device, a scanner, or a networking device such as switch or router, e.g., through a network adapter.

Computing device 300 may be implemented in a number of different forms, as shown in the figures. For example, computing device 300 may be implemented as a standard server 320, or in a group of such servers. Computing device 300 may also be implemented as part of a rack server system 324. In addition, computing device 300 may be implemented in a personal computer, such as a laptop computer 322. Alternatively, components from computing device 300 may be combined with other components in a mobile device, such as mobile computing device 350. Each of such devices may contain one or more computing devices 300, 350, and an entire system may be made up of multiple computing devices 300, 350 communicating with each other.

Mobile computing device 350 may include a processor 352, a memory 364, an input/output (“I/O”) device, such as a display 354, a communication interface 366, and a transceiver 368, among other components. Mobile computing device 350 may also be provided with a storage device, such as a micro-drive or other device, to provide additional storage. Each of the components 352, 364, 354, 366, and 368 are interconnected using various buses, and several of the components may be mounted on a common motherboard or in other manners as appropriate.

Processor 352 can execute instructions within mobile computing device 350, including instructions stored in memory 364. Processor 352 may be implemented as a chipset of chips that include separate and multiple analog and digital processors. Processor 352 may provide, for example, for coordination of the other components of mobile computing device 350, such as control of user interfaces, applications run by mobile computing device 350, and wireless communication by mobile computing device 350.

Processor 352 may communicate with a user through control interface 358 and display interface 356 coupled to a display 354. Display 354 may be, for example, a TFT LCD (Thin-Film-Transistor Liquid Crystal Display) or an OLED (Organic Light Emitting Diode) display or other appropriate display technology. Display interface 356 may include appropriate circuitry for driving display 354 to present graphical and other information to a user. Control interface 358 may receive commands from a user and convert the commands for submission to processor 352. In addition, an external interface 362 may be provided in communication with processor 352, so as to enable near area communication of mobile computing device 350 with other devices. External interface 362 may provide, for example, for wired communications in some implementations, or for wireless communication in other implementations, and multiple interfaces may also be used.

Memory 364 stores information within mobile computing device 350. Memory 364 can be implemented as one or more of a computer-readable medium or media, a volatile memory unit or units, or a non-volatile memory unit or units. Expansion memory 374 may also be provided and connected to mobile computing device 350 through expansion interface 372, which may include, for example, a SIMM (Single In Line Memory Module) card interface. Such expansion memory 374 may provide extra storage space for device 350, or may also store applications or other information for mobile computing device 350. Specifically, expansion memory 374 may include instructions to carry out or supplement the processes described herein, and may include secure information also. Thus, for example, expansion memory 374 may be provided as a security module for mobile computing device 350, and may be programmed with instructions that permit secure use of mobile computing device 350. In addition, secure applications may be provided via the SIMM cards, along with additional information, such as placing identifying information on the SIMM card in a non-hackable manner.

Expansion memory 374 may include, for example, flash memory and/or NVRAM memory. In some implementations, a computer program product is tangibly embodied in an information carrier. The computer program product contains instructions that, when executed, perform one or more methods, such as those described herein. The information carrier is a computer-or machine readable-medium, such as memory 364, expansion memory 374, or a memory on processor 352, that may be received, for example, over transceiver 368 or external interface 362.

Mobile computing device 350 may communicate wirelessly through communication interface 366, which may include digital signal processing circuitry where necessary. Communication interface 366 may provide for communications under various modes or protocols, such as GSM voice calls, SMS, EMS or MMS messaging, CDMA, TDMA, PDC, WCDMA, CDMA2000, or GPRS, among others. Such communication may occur, for example, through transceiver 368. In addition, short-range communication may occur, such as using a Bluetooth, WiFi, or other such transceiver. In addition, GPS (Global Positioning System) received module 370 may provide additional navigation-and location-related wireless data to mobile computing device 350, which may be used as appropriate by applications running on mobile computing device 350.

Mobile computing device 350 may also communicate audibly using audio codec 360, which may receive spoken information from a user and covert the received spoken information to digital information. Audio codec 360 may likewise generate audible sound for a user, such as through a speaker, e.g., in a handset of mobile computing device 350. Such sound may include sound from voice telephone calls, may include recorded sound, such as voice messages, music files, etc., and may also include sound generated by applications operating on mobile computing device 350.

Mobile computing device 350 may be implemented in a number of different forms, as shown in the figure. For example, mobile computing device 350 may be implemented as a cellular telephone 380. Mobile computing device 350 may also be implemented as part of a smart phone 382, personal digital assistant, or other similar mobile device.

Various implementations described herein can be realized in digital electronic circuitry, integrated circuitry, specially designed ASICs (application specific integrated circuits), computer hardware, firmware, software, and/or combinations thereof. These various implementations can include implementations in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs, also known as programs, software, software applications, or code, include machine instructions for a programmable processor, and can be implemented in a high-level procedural and/or object-oriented programming language, and/or in assembly/machine language. As used herein, the terms “machine-readable medium” and “computer-readable medium” refer to any apparatus and/or device, such as magnetic discs, optical disks, memory, Programmable Logic Devices (“PLDs”), used to provide machine instructions and/or data to a programmable processor, including a machine-readable medium that receives machine instructions as a machine-readable signal. The term “machine-readable signal” refers to any signal used to provide machine instructions and/or data to a programmable processor.

The contents of computer-readable medium may physically reside in one or more memory devices accessible by server. Computer-readable medium may include a database of entries corresponding to certain subject matter disclosed herein. A user or organization's information may be provided in information fields and stored in a database, as set forth herein. Said fields are customizable and may include additional or alternative fields based on the user's needs. Said information is accessible through the server.

To provide for interaction with a user, the techniques described herein can be implemented on a computer having a display device, such as a CRT (cathode ray tube), LCD (liquid crystal display), or LED (Light Emitting Diode) monitor, for displaying information to the user and a keyboard and a pointing device by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input.

The techniques described herein can be implemented in a computing system that includes a back end component, such as a data server, or that includes a middleware component, such as an application server, or that includes a front end component, such as a client computer having a graphical user interface or Web browser through which a user can interact with an implementation of the techniques described here, or any combination of such back end, middleware, or front end components.

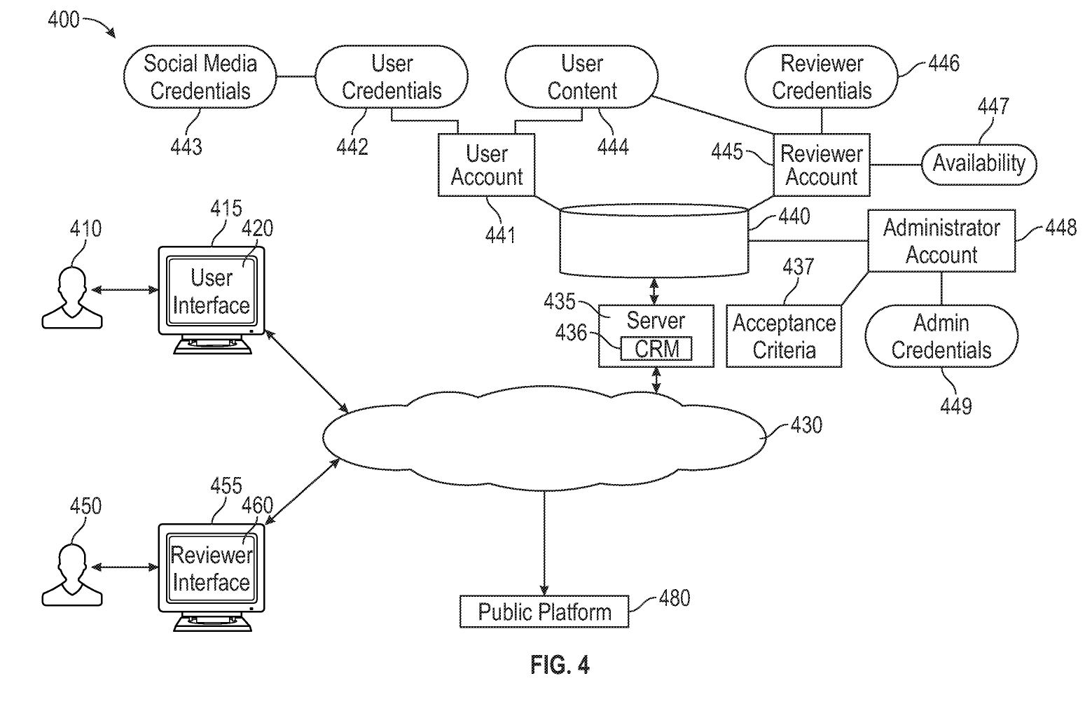

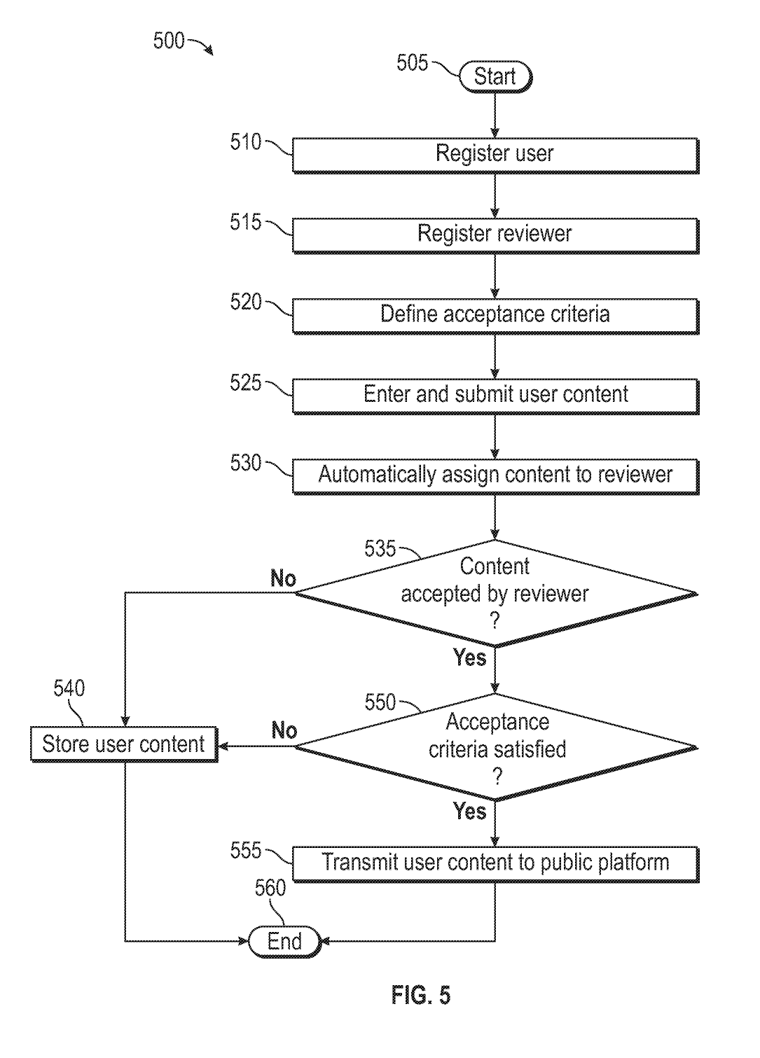

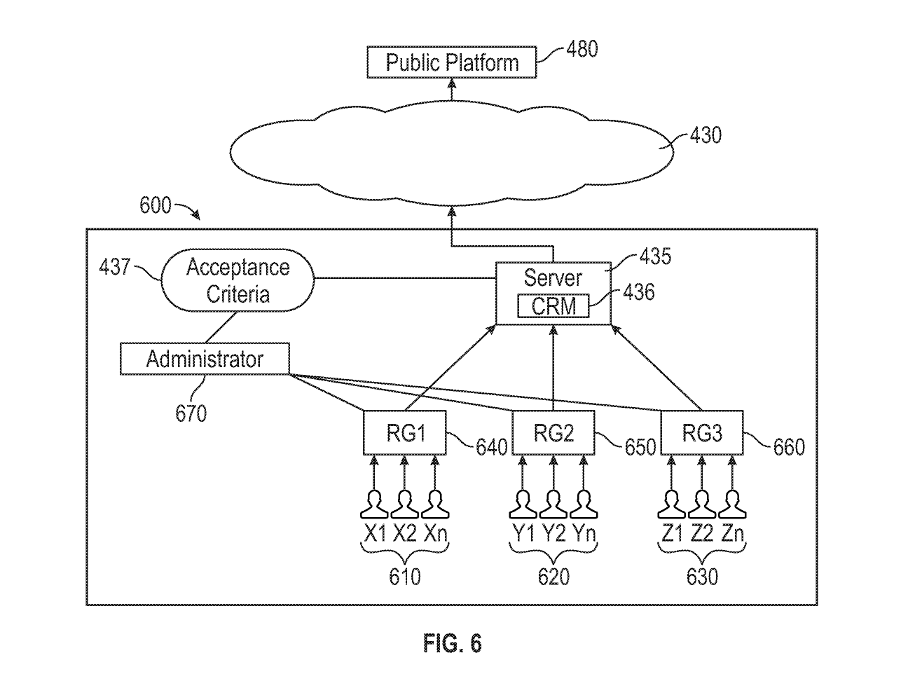

FIGS. 4 and 5 illustrate preferred embodiments of a system and method, for regulating the transmission of user content to a public platform. FIG. 5 is a flowchart 500 illustrating various method steps that may be carried out to regulate the transmission of user-created content to a public platform. It is understood that the various method steps associated with the method illustrated within FIG. 5 may be carried out as operations by the system 400 shown in FIG. 4 or a private network 600 using the components of system 400, as best shown in FIG. 6.

As shown in FIG. 4, the system of the present disclosure generally comprises: a first computing device 415; a second computing device 455; a database 440; and a server 435 operably connected to the first computing device 415, the second computing device 455, and the database 440. The first computing device 415 is configured to display a user interface 420 thereon and to receive and subsequently transmit user content inputted into the user interface 420 by a user 410 to the server 435. The first computing device 415 may be any mobile or stationary computing device suitable for carrying out such operations including, but not limited to, laptops, desktops, workstations, personal digital assistants, mainframes, cellular telephones, tablet computers, or any other similar device. Accordingly, the inventive subject matter disclosed herein, in full or in part, may be implemented or utilized in devices including but not limited to laptops, desktops, workstations, personal digital assistants, mainframes, cellular telephones, tablet computers, or any other similar device. The first computing device 415 is operably connected to the server 435 such that first computing device 415 may transmit information to or receive information from the server 435. As shown in FIG. 4, the first computing device 415 may be operably connected to the server 435 wirelessly via a network 430. Alternatively, the first computing device may be operably connected to the server 435 via a wired connection.

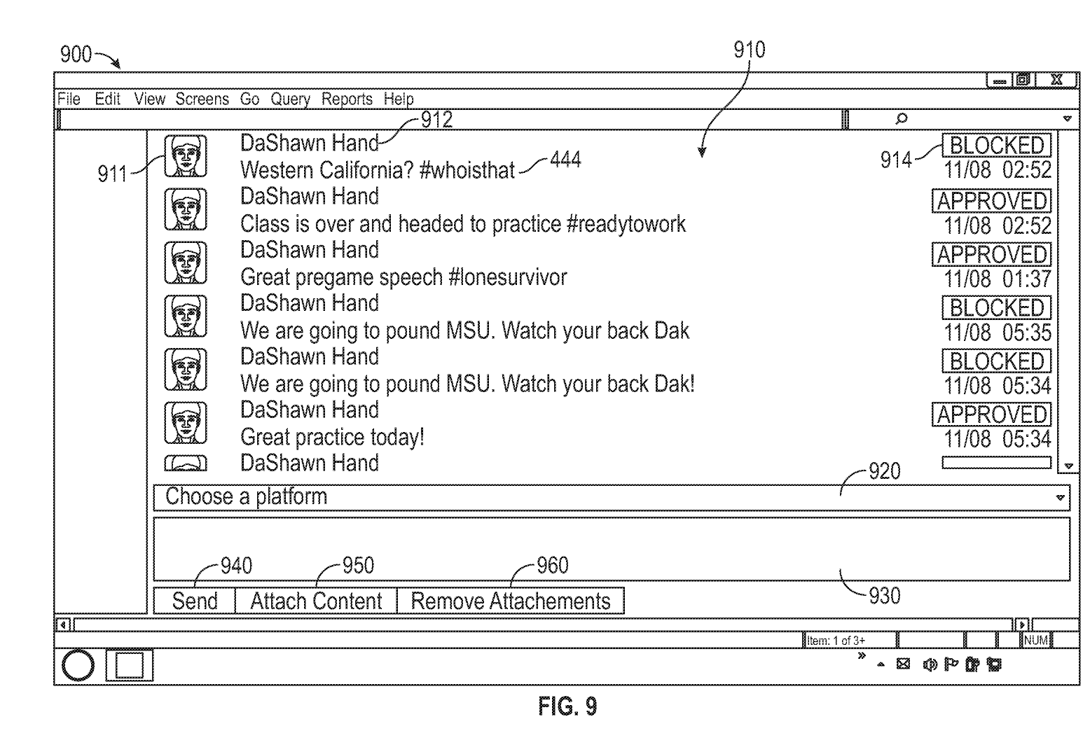

The user interface 420 is configured to be presented on the display of the first computing device 415 and to prompt a user 410 to input certain information within defined fields of the user interface 420. The user interface 420 may comprise a plurality of user interface pages. For instance, as shown in FIG. 9, the user interface 420 may have a content creation page 900 that allows users to submit user content 444 for review in the manner disclosed herein. The content creation page 900 preferably has text field 930 in which a user 410 may input text for submission to the server 435 and one or more commands 940-960. As shown in FIG. 9, the content creation page 900 may have a send command 940, an attach content command 950, and a remove attachments command 960. The send command 940, when selected by the user 410 initiates the transmission of any text within the text box 930 or attached content to the server 435. The attach content command 950, when selected by the user 410, may open one or more windows that allow the user 410 to select one or more content files, such as images or videos, from the first computing device 415 for subsequent transmission to the server 435. The remove attachments command 960, which when selected by the user 410, removes any content files selected for transmission to the server 435.

As further shown in FIG. 9, the content creation page 900 also preferably contains a dropdown menu 920, or other similar field selection tool, that is populated with a list of public platform 480 to which the user 410 desires their content to be transmitted to and publicly displayed on. In a preferred embodiment, the dropdown menu 920 is populated with a list of available social media platforms. Such social media platforms may include, but are not limited to, Facebook, Instagram, Snapchat, Twitter, Vine, or any other social media platform to which the user 410 may be a member of. In one preferred embodiment, the content creation page 900 may also contain a content history field 910 that displays user content 444 previously submitted by the user 410 for review in the manner disclosed herein. The content creation page 900 may be further configured to display a profile picture 911 associated with and selected by the user 410 thereon. The content creation page 900 may also display the review status 914 of each piece of user content 444 displayed within the content history field 910. Each review status 914 may have a time stamp associated therewith indicating the time in which user content 444 submitted by the user 410 was approved or blocked from being transmitted to the public platform 480.

The user interface 420 may further comprise a member configuration page (not shown) configured to prompt a user 410 to provide certain information and subsequently transmit such information to the server 435 for storage within the database 440. In a preferred embodiment, the user 410 utilizes the member configuration page to create a user account 441 within the system and to provided the user credentials 442 and social media credentials 443 associated with the user account 441. The member configuration page may be designed to prompt the user to provide and subsequently capture information including, but not limited to, user address, phone number, and/or email address. In a preferred embodiment, the member configuration page prompts the user to create a username and password that must be entered by the user 410 and verified by the server 435 prior to user 410 being permitted to submit content for review.

The second computing device 455 is configured to display a reviewer interface 460 and to transmit instructions relating to the acceptance or rejection of user content inputted into the reviewer interface 460 by a reviewer 450. The second computing device 455 may be any computing device for carrying out such operations including, but not limited to, laptops, desktops, workstations, personal digital assistants, mainframes, cellular telephones, tablet computers, or any other similar device. The second computing device 455 is operably connected to the server 435 such that the second computing device 455 may transmit information to or receive information from the server 435. The second computing device may be operably connected to the server 435 via a wired or wireless connection.

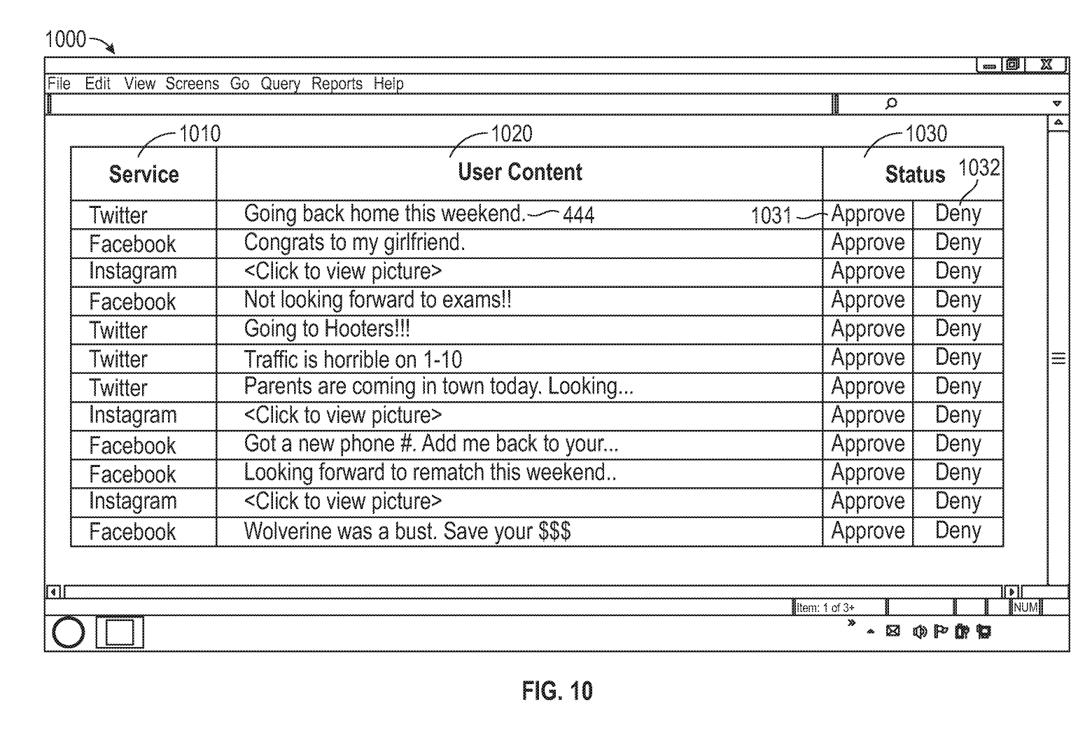

The reviewer interface 460 is configured to be presented on the display of the second computing device 455 and to prompt a reviewer 450 to input certain information or select instructions provided within the defined fields of the reviewer interface 460. The reviewer interface 460 may comprise a plurality of reviewer interface pages. For instance, as shown in FIG. 10, the reviewer interface 460 may have a content review page 1000 that allows a reviewer 450 having sufficient reviewer credentials 446 to review content that submitted by a user 410 for review and assigned to the reviewer 450. The content review page 1000 preferably has a service field 1010, a user content field 1020, and a status field 1030 associated therewith. As shown in FIG. 10 the service field 1010 is populated with the public platform 480 to which a user 410 has indicated they would like to transmit a piece of user content 444 to. The user content field 1020 is populated with user content 444 that users 410 have submitted for review by the system 400 and which have been assigned to the reviewer 450 in the manner disclosed herein. The status field 1030 is preferably populated with commands 1031-1032 relating to the reviewer's 450 review of the user content 444 within the user content field 1020.

As shown in FIG. 10, the content review page preferably allows the reviewer 450 to select one of two commands, an approve command 1031 or a deny command 1032. The approve command 1031, when selected by the reviewer 450, transmits instructions to the server 435 indicating that the reviewer has reviewed a piece of user content 444 and has approved the content for transmission to the one or more public platforms 480 associated with the user content 444 as indicated by the service field 1010. The deny command 1032, when selected by the reviewer 450, transmits instructions to the server 435 indicating that the reviewer 450 has reviewed a piece of user content 444 and has rejected the content for transmission to the one or more public platforms 480 associated with the user content 444, as indicated by the service field 1010. A reviewer's 450 acceptance or rejection of a piece of user content 444, as defined by the reviewer's selection of the accept command 1031 or deny command 1032, preferably has metadata associated therewith. For instance, such meta data may include a timestamp associated with the reviewer's 450 acceptance or rejection of a piece of user content 444 that indicates the date and/or time in which such acceptance or rejection was made by the reviewer 450. In such embodiments, the server 435 is preferably configured to abstract such metadata from the reviewer's 450 acceptance or rejection of a piece of user content 444 and utilize such metadata for comparison with acceptance criteria 437 defined by an administrator.

The reviewer interface 460 may further comprise a reviewer configuration page (not shown) configured to prompt a reviewer 450 to enter certain information and subsequently transmit such information to the server 435 for storage within the database. In a preferred embodiment, a reviewer 450 or administrator utilizes the reviewer configuration page to create a reviewer account 445 within the system 400 and to provide reviewer credentials 446 that will be associated with the reviewer account 445. The reviewer credentials 446 inputted by the reviewer 450 or administrator 670 may include but are not limited to, reviewer 450 name, address, phone number, and/or email address. In a preferred embodiment, the reviewer configuration page prompts the reviewer 450 or administrator 670 to create a username and password that must be entered by the reviewer 450 and verified by the server 435 prior to the reviewer 450 accessing their reviewer account 445 and reviewing user content 444 assigned to the user. In one preferred embodiment, as shown in FIG. 4, the reviewer 450 or administrator 670 may be required to input reviewer 450 availability data 447 into the reviewer configuration page.

In a preferred embodiment, the system 400 may further comprise an administrator interface (not shown) configured to be presented on a computing device within the system and to prompt an administrator 670 to input certain information within defined fields of the administrator interface. The administrator interface may comprise a plurality of interface pages. For instance, the administrator interface may have a content acceptance page that allows an administrator 670 having sufficient administrator credentials 449 to define a set of acceptance criteria 437.

The acceptance criteria 437 preferably relates to the one or more reviewers' acceptance or rejection of user content 444. In a preferred embodiment, the set of acceptance criteria 437 relates to the number of reviewers 450 that are required to accept a piece of user content 444 before the user content 444 may be transmitted to the public platform 480 for public display. In another preferred embodiment, the set of acceptance criteria 437 defined by the administrator 670 may relate to the timestamp associated with reviewer 450 acceptance or rejection of a piece of user content 444. In such embodiments, acceptance criteria 437 defines a range of days and/or times to which a piece of user content 444 accepted by a reviewer 450 may be transmitted for publication on a selected public platform 480. If the timestamp associated with the reviewer's 450 acceptance of a piece of user content 444 falls within the day and/or time ranges defined by the acceptance criteria 437, the user content 444 may be transmitted by the server 435 to the public platform 480 for publication. If the timestamp associated with a reviewer's 450 acceptance of a piece of user content 444 falls outside the defined day and/or time ranges, the server 435 may delay the transmission of the user content 444 to the public platform until an acceptable day and/or time for such transmission, as set forth within the acceptance criteria 437.

To navigate through the various pages of the user interface 420, reviewer interface 460, and/or administrator interface, a series of links or tabs may be incorporated into the pages of such interfaces. In a preferred embodiment, the various pages of the interfaces disclosed herein may be accessed via a website or mobile application associated with the system 400.

The database 440 is operably connected to the server 435 such that the server may retrieve information stored within the database 440 or transmit information to the database 440 for storage therein. The database 440 is configured to store a plurality of accounts and account credentials therein. As shown in FIG. 4, the database 440 is preferably configured to store user accounts 441, reviewer accounts 445, administrator accounts 448, and the information associated with or tied to such accounts therein. Each user account 441 stored within the database 440 has a set of reviewer credentials 442 tied thereto. Each set of user credentials 442 corresponds to a specific user 410. User credentials 442 may comprise login credentials (such as a username and/or password), which must be entered into the user interface 420 and verified by the server 435 before a user 410 may submit content for review in the manner disclosed herein. As shown in FIG. 4, the user credentials 442 may comprise, at least partially, one or more social media account credentials 443 of the user 410, wherein each of the social media credentials corresponds to a social media platform, such as Facebook, Snapchat, Twitter, or Instagram. The social media credentials 443 are preferably such that when entered and submitted to the login page or portal of the corresponding social media platform, the user 410 is granted access to their account on the social media platform. In a preferred embodiment, user content 444 submitted by the user 410 for review in the manner disclosed herein may be stored within the database 440 and tied to the user's 410 user account 441.

Each reviewer account 445 stored within the database 440 has a set of reviewer credentials 446 tied thereto, which correspond to a specific reviewer 450. Reviewer credentials 446 may comprise login credentials (such as a username and/or password) which must be entered into the reviewer interface 460 and verified by the server 435 prior to the reviewer 450 gaining access to user content 444 submitted for review by a user 410. Reviewer accounts 445 within the database may have additional information tied thereto, such as availability data 447 containing information pertaining to the dates and/or times in which the reviewer 450 is available to review user content 444. As shown in FIG. 4, each reviewer account 445 within the database 440 is preferably tied to at least one user account 441 within the database 440 such that a reviewer 450 may access and review user content 444 tied to the user accounts 441 to which the reviewer's 450 reviewer account 445 is tied. In some preferred embodiments, each reviewer account 445 may be further tied to one or more review groups as disclosed herein. In one preferred embodiment, each reviewer account 445 may have the reviewer history data tied thereto, wherein the reviewer history data contains information relating to a reviewer's 450 review of user content 444 over a defined period of time. Such reviewer history data may be generated by the server 435 based on information transmitted to the server 435 from the second computing device 455 via the reviewer interface 460 and subsequently transmitted to the database 440 for storage therein.

Each administrator account 448 has a set of administrator credentials 449 tied thereto, which correspond to a specific administrator 670. Administrator credentials 449 may comprise login credentials (such as a username and/or password) which must be entered into an administrator interface (not shown) and verified by the server 435 before the administrator 670 can define acceptance criteria 437 or assign reviewer accounts 445 to review groups in the manner disclosed herein. In a preferred embodiment, the database 440 is further configured to store acceptance criteria 437 defined by an administrator 670 therein.

In some embodiments, the system 400 may utilize one or more database management systems such as Microsoft SQL, PostgreSQL, or any other similar database management system.

The server 435 is configured to perform the operations disclosed herein based on programming instructions stored within the system 400. The server 435 may be any server or device suitable for executing such program instructions. In some embodiments, the server 435 may have a memory device therein suitable for storing certain information or data disclosed herein. In some instances, the server 435 may be a component of a larger computing device.

In a preferred embodiment, the programming instructions responsible for the operations carried out by the server 435 are stored on a non-transitory computer-readable medium 436 that is coupled to the server 435, as shown in FIG. 4. Alternatively, such programming instructions may be stored or included within the server 435. Examples of non-transitory computer-readable mediums include, but are not limited to, magnetic media such as hard disks, floppy disks, and magnetic tape; optical media such as CD ROM discs and DVDs; magneto-optical media such as optical discs; and hardware devices that are specifically configured to store and perform programming instructions, such as read-only memory (ROM), random access memory (RAM), flash memory, and the like. In some embodiments, the programming instructions for the server 435 may be stored as programming modules within the non-transitory computer-readable medium 436.

As best illustrated by FIG. 6, the first computing device 415, the second computing device 455, the server 435, and the database 440 may be connected in a manner as to form a private network 600. The private network 600 is preferably structured such that user content 444 generated within the private network 600 can only be transmitted from the private network 600 to the public platform 480 by the server 435 after a thorough review of the user content 444 is conducted. As further shown in FIG. 6, an external network 430 may serve as an intermediate between the private network 600 and the public platform 480 that facilitates the transmission of information between the server 435 and the public platform 480. In some embodiments, the private network 600 may be a local-area network (LAN), a wide-area network (WAN), or virtual-private network (VPN). However, one of skill in the art will appreciate that other system architectures may be use without departing from the inventive subject matter disclosed herein.

FIG. 5 provides a flowchart 500 illustrating certain, preferred method steps that may be used to carry out the method of the present disclosure. Step 505 indicates the beginning of the method of the present disclosure. In user registration step 510, a user account 441 corresponding to a user 410 is created and subsequently stored within the database 440. In a preferred embodiment, the user 410 creates the user account 441 by inputting user credentials 442 and social media credentials 443 into the first computing device 415 within various fields provided within the user interface 420. The information entered by the user 410 to create a user account 441 is subsequently transmitted to the server 435. Once received, the server 435 stores such information within the database 440 for later use.

In reviewer registration step 515, one or more reviewer accounts 445 corresponding to one or more reviewers 450 is created and subsequently stored within the database 440. Preferably, a plurality of user accounts 445 are created such that multiple reviewers 450 may review user content 444 in the manner disclosed below. To create a reviewer account 445, a reviewer 450 or administrator 670 is required to transmit a set of reviewer credentials 446 to the server 435, preferably via the reviewer configuration page of the reviewer interface 460. When creating a reviewer account 445, the reviewer 450 or administrator 670 may also be required to transmit availability data 447 to the server 435. Once received, the server 435 stores such information within the database 440 for later use.

Only individuals who are approved by an administrator 670 for designation as a reviewer 450, or other managerial figure or entity with sufficient credentials to manage accounts within the system 400, may be designated as a reviewer 450 and have a reviewer account 445. Preferably, approval of individuals requesting or submitted for reviewer designation is limited to only those individuals having a sufficient familiarity level with the user 410 and/or organizations to which the user 410 is affiliated.

The familiarity level to which an individual must achieve to be approved for reviewer designation and criteria governing the measure of an individual's familiarity level is preferably set by an administrator 670. An individual's familiarity level with the user 410 and/or organizations to which the user 410 is affiliated may be based on the individual's knowledge of matters central to the user 410 and/or affiliated organization. Such matters may include, but are not limited to, the user 410 and/or affiliated organization's mission statement, public relation goals, human relation goals, political goals, legal goals, and/or other similar matters. In a preferred embodiment, and individual's knowledge of such matters is objectively measured via one or more tests or assessments. For instance, if the threshold familiarity level set by the administrator 670 is based solely on individual familiarity with the public relation goals of an organization affiliated with the user 410, an individual may be required to achieve a certain score on a test relating to that organization's public relation policies.

Thus, limiting reviewers only to those individuals having a sufficient familiarity level with the user 410 and/or organization's affiliated with the user 410 serves ensure that user content 444 submitted by a user 410 for review is reviewed and accessed by one or more individuals capable of deciphering the appropriateness or inappropriateness of the content in the context of the user 410 and/or affiliated organization's central values. That is, limiting reviewer designation in this manner facilitates more accurate identification of user content 444 as either suitable or unsuitable for publication based on the manner in which such content may adversely affect the user 410 and/or organization's affiliated with the user 410 than is currently provided for within the art.

In step 520, an administrator 670 defines a set of acceptance criteria 437 relating to reviewer 450 acceptance or rejection of the user content 444 submitted for review. As noted above, in a preferred embodiment, the acceptance criteria relates to the number of reviewers 450 which must approve a piece of user content 444, the time in which reviewers 450 accept a piece of user content 444 for transmission to a public platform 480, or both. In content generation step 525, a user 410 inputs and submits a piece of user content 444 for submission to the public platform 480. Prior to submitting the piece of user content 444, the user 410 may be required to select one or more social media platforms from the dropdown menu 920 of the content creation page 900 to which the user 410 desires the content be submitted to for publication. Preferably, the user 410 enters and submits user content 444 within the content creation page 900 of the user interface 420 using the first computing device 415. User content 444 submitted in this manner is subsequently transmitted to the server 435. Prior to carrying out step 520, a user 410 may be required to log into their user account 444. To log into their user account 444 the user 410 enters their user credentials into the user interface 420 using the first computing device 415. The user credentials entered by the user 410 are transmitted to the server 435, which subsequently compares the credentials entered by the user 410 to the user credentials 442 tied to the user's 410 user account 441. If the server 435 determines a match between the entered credentials and the user credentials 442 associated with the user's 410 user account 441, the user 410 is logged into their user account 441. Once logged into their user account 441, any user content 444 submitted by the user is associated with the user's 410 user account 441.

Upon receiving user content 444 submitted by the user 410, the server 435 automatically assigns the user content 444 to one or more reviewers 450 for review. In a preferred embodiment, after assigning the user content 444, the server may be configured to notify each reviewer 450 to which the user content 450 is assigned. In one preferred embodiment, the server 435 may generate an email notification and transmit the notification to a reviewer 450 using the reviewer credentials 446 tied to the reviewer's 450 reviewer account. In some instances, the server 435 may generate a text message notification and transmit the message to the reviewer 450 using the reviewer's 450 reviewer credentials 446. One of skill in the art will readily appreciate that other methods of generating and transmitting reviewer notifications may be used without departing from the inventive subject matter disclosed herein. In another preferred embodiment, the server 435 may be further configured to notify the user 410 their user content 444 has been accepted or denied for transmission to the selected public platforms 480 and transmit such notification to the user 410 using the user credentials 442 tied to the user's 410 user account 441. In some instnaces, the server 435 may notify users 410 or 450 via push notifications on a mobile application installed on a user 410 or reviewer's 450 mobile device.

In a preferred embodiment, each user account 441 within the database 440 may be tied to one or more reviewer accounts 445 within the database 440. Reviewer accounts 445 are preferably tied to user accounts 441 such that a reviewer 450 may access and review user content 444 tied to the user accounts 441 to which the reviewer's 450 reviewer account 445 is tied. In such embodiments, the server 435 may assign user content 444 submitted by the user 410 based on the one or more reviewer accounts 445 to which that user's 410 user account 441 is tied. The server 435 may assign the user content 444 to all reviewers 450 having a reviewer account 445 tied to the user's 410 user account 441. Alternatively, the server may only assign the user content 444 to a defined number of reviewers 450 having a reviewer account 445 tied to the user's 410 user account 441. In some instances, the server 435 may assign a piece of user content 444 to reviewers 450 based, at least in part, on availability data 447 stored within the database 440.

Once user content 444 is assigned to a reviewer 450, the reviewer 450 may access the assigned user content via the second computing device 460 using the content review page 1000 of the reviewer interface 460. Prior to accessing the assigned user content 444 or content review page 1000, the reviewer 450 may be required to enter their respective reviewer credentials into the reviewer interface 460. The credentials entered by the reviewer 450 is transmitted to the server 435, which subsequently compares the entered credentials to the reviewer credentials 446 tied to the reviewer's 450 reviewer account 445. If the server 435 determines a match between the entered credentials and the reviewer credentials 446 tied to the reviewer's 450 reviewer account 445, the reviewer 450 is granted access to the reviewer's 450 reviewer account 445. Once the reviewer 450 has accessed their reviewer account 445, the server 435 may transmit the user content 444 to the content review page 1000 of the reviewer interface 455 for the reviewer 450 to review. Preferably, the reviewers 450 assigned the piece of user content 444 submitted by the user 410 define a set of context criteria to govern reviewer acceptance or rejection of the user content 444 for transmission the selected public platforms 480. The content criteria defined by the reviewers 450 may pertain to one or more rules, goals, values, regulations, and/or policies of the user 410 and/or affiliated organization. Once such context criteria is defined, the reviewers 450 analyzes the user content 444 submitted by the user 410 to determine whether the user content 444 complies with the set of context criteria.

As shown in step 535 in FIG. 5, based on the nature of the user content 444 submitted by the user 410, the reviewers 450 either accept or reject the user content 444 for publication on the selected public platforms 480. If the nature of the user content 444 is in compliance with the context criteria defined by the reviewers 450, the reviewers accept the user content 444 for transmission to the selected public platforms 480. If the nature of the user content 444 is not in compliance with the defined context criteria, the reviewers reject the user content 444 for transmission to the selected public platforms 480.

If the user content 444 is rejected by all of the reviewers 450 assigned the content, the user content 444 is preferably stored within the database 440 in step 540 such that the user content 444 is tied to the user's 410 user account 441, as shown in FIG. 4. If the user content 444 is accepted, the server 435 compares the reviewers' acceptance or rejection of the user content 444 to the set of acceptance criteria 437 defined by the administrator 670 in step 550. If the reviewers' 450 acceptance or rejection of the user content 444 complies with the set of acceptance criteria 437, the server 435 determines the reviewers' acceptance or rejection as matching the acceptance criteria 437 and subsequently transmits the user content 444 to the public platforms 480 selected by the user 410. Conversely, if the reviewers' 450 acceptance or rejection of the user content does not comply with the set of acceptance criteria 437, the server 435 determines a non-match and blocks or prevents transmission of the user content 444 to the public platforms 480 selected by the user 410. In one preferred embodiment, the server 435 abstracts metadata from the reviewers' acceptance or rejection of the user content 444 and utilizes such metadata to determine a match between the reviewers' acceptance or rejection of the user content 444 and the set of acceptance criteria 437.

Upon determining a non-match between the reviewers' acceptance or rejection of the user content 444 and the acceptance criteria 437, the server 435 may transmit the user content 444 to the database 440 for storage therein. In some instances, the user content may be transmitted and subsequently stored within the database 440 even if the server 435 determines a match and subsequently transmits the user content 444 to the selected public platforms 480. Prior to transmitting the user content 444 to the selected public platforms 480, server 435 may transmit the social media credentials 443 associated with the user's 410 user account 441 to their respective social media platforms, thereby permitting the server 435 to share the user content 444 in association with the user's 410 social media accounts. Step 560 indicates the end of the method.

In one preferred embodiment, the server 435 may be configured to generate user 410 and or reviewer 450 reports. User reports comprise all of the user content 444 a user 410 has submitted for review over a defined period of time, e.g., over the course of a month. In generating such user reports, the server 435 may retrieve user content 444 from the database 440. Reviewer reports comprise all of the user content 444 a reviewer 450 has been assigned, rejected, and/or approved within a defined period of time and the users associated with that content. The server 435 may be configured to generate reviewer reports which indicate reviewer 450 productivity and/or average time spent to approve or reject a piece of user content 444.

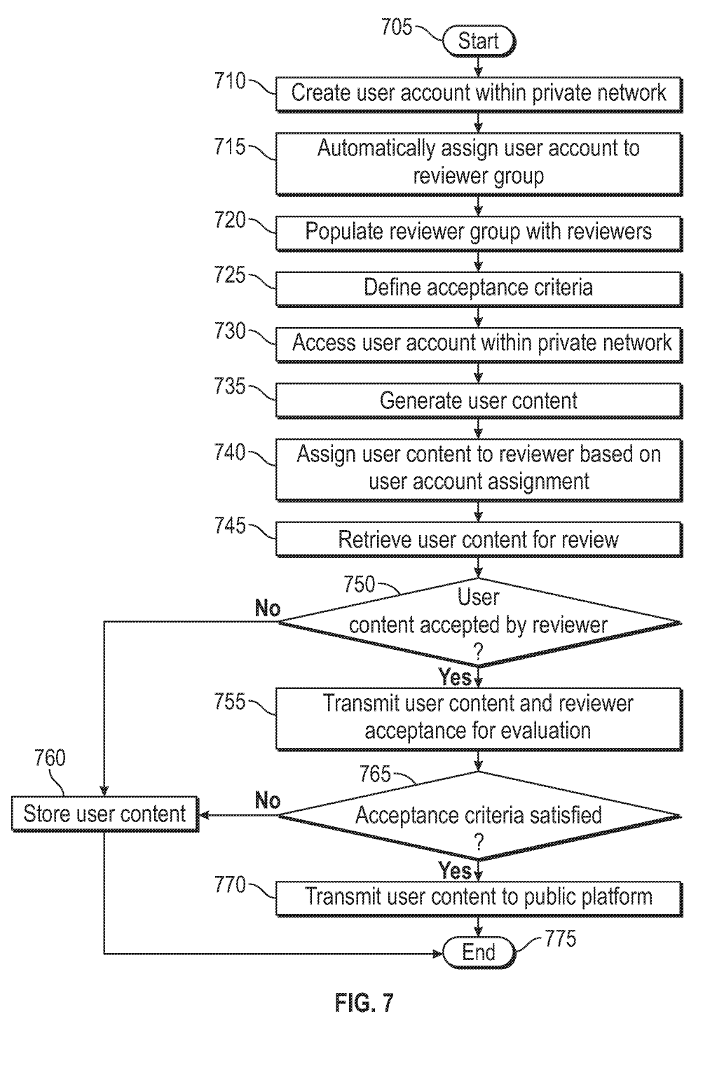

As shown by the flowchart 700 shown in FIG. 7, the above-described method may be utilized within a private network 600 to regulate the transmission of user content 444 from a private network 600 to one or more external public platforms 480 selected by a user 410. Step 705 indicates the beginning of a method relating to the same. In such embodiments, a user account 441 is created within the private network 600 in step 710 in the same or similar fashion to that previously disclosed above for user registration step 510. Once the user account 441 is created and stored within a database 440 within the private network 600, the user account 441 is assigned, by and administrator 670, to one or more review groups 640-660 within the private network 600 in step 715. A user's 410 user account 441 may be assigned to a single or multiple reviewer groups of the plurality of review groups 640-660.

Prior to step 715, the administrator 670 may be required to define a plurality of review groups 640-660 within the private network 600. The defined review groups 640-660 may be stored within the database 440. Each review group of the plurality of review groups 640-660 preferably has a set of context criteria associated therewith that governs the acceptance or rejection of user content 444 for transmission to the public platforms 480 selected by the user 410. Preferably each review group has a different set of acceptance criteria, where each set of acceptance criteria relates to matters or values central to the user 410 and/or organizations affiliated with the user 410. For instance, a first review group 640 may have context criteria associated therewith that limits user content 444 approval only to content which reviewers 610 assigned to the first review group 640 do not determine to not be legally adverse to the user 410 and/or organizations affiliated with the user 410. A second review group 650 may have context criteria associated therewith that limits user content 444 approval only to content which reviewers 620 assigned to the second review group 650 determine is not adverse to the user 410 and/or affiliated organizations' public relation goals. Similarly, a third review group 660 may have context criteria associated therewith which limits user content approval 444 only to content which reviewers 630 assigned to the third review group 660 determine is not adverse to the user 410 and/or affiliated organizations' human relation goals. Though it is understood that the context criteria associated with a review group may be related to other matters without departing from the inventive subject matter disclosed herein.

In the same or similar fashion as disclosed for step 515 above, a plurality of reviewer accounts 445 are created and stored within the private network's 600 database 440. In step 720, each review group of the plurality of review groups 640-660 within the private network 600 is populated with a group of reviewers 610-630 by assigning each reviewer account 445 within the private network's 600 database 440 to one or more review groups 640-660 such that the reviewer 450 associated with each reviewer account 445 is assigned to one or more review groups. As shown in FIG. 6, the assignment of reviewer accounts 445 to review groups is preferably carried out by an administrator 670 via an administrator interface. As further shown in FIG. 6 the group of reviewers 610-630 associated with a review group may contain any number of reviewers 450. In step 725, an administrator defines a set of acceptance criteria 437 relating to reviewers' acceptance or rejection of user content 444. Step 725 may be carried out in the same or similar manner as that disclosed above for step 520.

In step 730, a user 410 accesses their user account 441 within the database 440 of the private network 600 by inputting credentials into the user interface 420 and transmitting the entered credentials to the private network's 600 server 435. Upon receipt of the credentials entered by the user 410, the server 435 compares the entered credentials with the user credentials 442 associated with the user's 410 user account 441. Upon the server determining a match therebetween, the user 410 is granted access to their user account 441. Once a user 410 has accessed their user account 441, the user 410 is permitted to generate content 444 for submission to one or more public platforms 480 in step 735. Preferably, the user 410 generates user content 444 via the content creation page 900 of the user interface 420. Each piece of user content 444 created by the user 410 is associated with the user's 410 user account 441. Content generated by the user 410 is transmitted to the server 435 for reviewer assignment in step 740.

Upon receipt of a piece of user content 444, the server 435 assigns the piece of user content 444 to one or more reviewer accounts 445 within the private network's 600 database 440. Preferably, the server 435 assigns user content 444 based on the one or more review groups to which the user account 441 is assigned such that reviewers 450 corresponding to the one or more reviewer accounts 445 assigned to the reviewer group to which the user content 444 is assigned may access the user content 444. In some embodiments, a reviewer 450 may be required to login to their reviewer account 445 to access user content 444 assigned thereto. Once a reviewer 450 has successfully logged into their reviewer account 445, the server 435 transmits the user content 444 assigned to their reviewer account 445 to the reviewer interface 460 in step 745. Once presented on the reviewer interface 460, the reviewers 450 assigned the piece of user content 444 analyze the piece of user content 444 to determine whether the content complies with the set of context criteria associated with the reviewers' assigned review group in step 750. If the reviewers determine the user content 444 satisfies the context criteria associated with the reviewers' assigned review group, the reviewers will accept or approve the user content for transmission to the public platforms 480 chosen by the user 410. If the reviewers determine the user content 444 does not satisfy the context criteria associated with the reviewers' assigned review group, the reviewers will reject the user content for transmission to the public platforms 480 chosen by the user 410. If all reviewers reject the user content 444, the user content 444 is preferably stored within the private network's 600 database 440 in step 760 and the user content 444 is not transmitted to the selected public platforms 480. If accepted by at least one of the reviewers, the user content 444 and reviewer acceptance data is transmitted to the server 435 in step 765 for subsequent evaluation.

In step 765, the server 435 compares the reviewers' acceptance or rejection of the user content 444 to the acceptance criteria 437 defined in step 725 to determine if the reviewers' acceptance or rejection of user content 444 satisfies the acceptance criteria 437. If the reviewers' 450 acceptance or rejection of the user content 444 complies with the set of acceptance criteria 437, the server 435 determines the reviewers' acceptance or rejection of the user content as matching the acceptance criteria 437 and subsequently transmits the user content 444 from within the private network to the external public platforms 480 selected by the user 410. Conversely, if the reviewers' acceptance or rejection of the user content 444 does not comply with the set of acceptance criteria 437 the server 435 determines a non-match and blocks or prevents transmission of the user content 444 outside of the private network 600. In some embodiments, the server 435 may abstract metadata from the reviewers' acceptance or rejection of the user content 444 and utilize such metadata to determine a match between the reviewers' acceptance or rejection of the user content 444 and the set of acceptance criteria 437.

Upon determining a non-match between the reviewers' acceptance or rejection of the user content 444 and the acceptance criteria 437, the server 435 may transmit the user content 444 to the database 440 for storage therein in step 760. In some instances, the user content may be transmitted and subsequently stored within the database 440 even if the server 435 determines a match and subsequently transmits the user content 444 outside of the private network 600 to the selected public platforms 480. Prior to transmitting the user content 444 to the selected public platforms 480, server 435 may transmit the social media credentials 443 associated with the user's 410 user account 441 to their respective social media platforms, thereby permitting the server 435 to share the user content 444 in association with the user's 410 social media accounts. Step 775 indicates the end of the method.

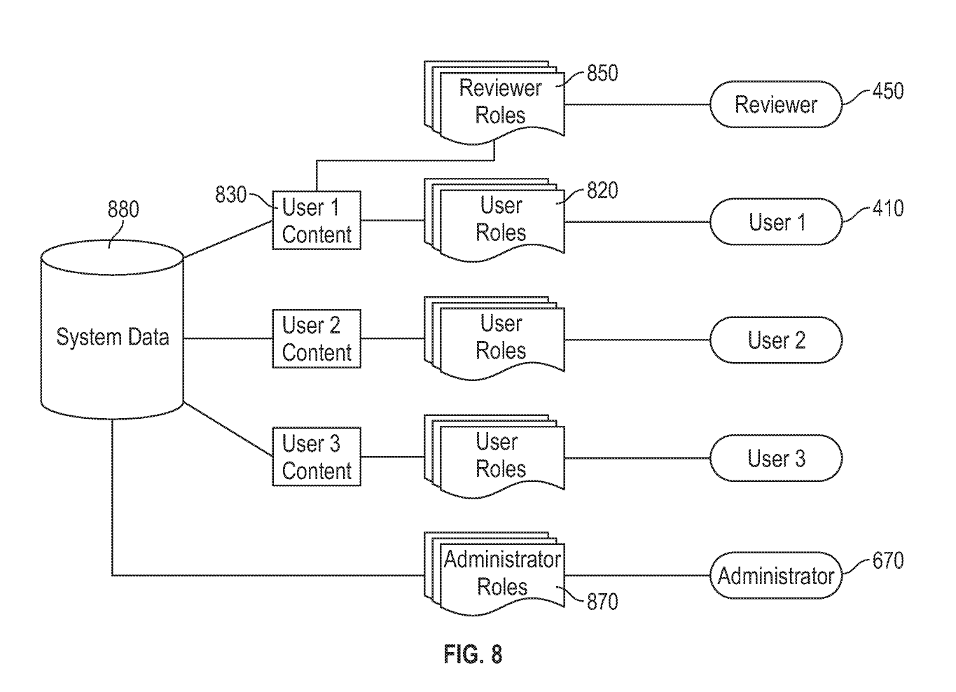

To submit user content 444 for review in the manner described above, the user 410 may be required to make a user request requesting permission to submit user content to the server 435. To prevent unwanted users from utilizing the system and method of the present disclosure, a user's 410 request to submit user content 444 may be limited based on the server's 435 of the user's 410 permission level. If the user's permission level is sufficient, the server 435 grants the user 410 permission to submit user content 435 to the server 435. Conversely, if the user's 410 permission level is insufficient, the server 435 will deny the user's 410 request and prevent the user 410 from submitting content to the server 435. As shown in FIG. 8, a user's 410 permission level may be based on user roles 820. User roles 820 allow users 410 registered within the system to access information that is tied to the user's 410 user account 441 within the database 440 and to submit user content 444 to the server 444.

To access user content 444 assigned to a reviewer 450, the reviewer 450 may be required to make a reviewer request to access and view the assigned user content 444. To prevent unauthorized individuals from accessing the user content 444, access to the assigned user content 444 may be granted or denied by the server 435 based on the server's 435 verification of the reviewer's 450 permission level. If the reviewer's permission level is sufficient, the server 435 provides the reviewer access to the assigned user content 444 within the database 440. Conversely, if the reviewer's 450 permission level is insufficient, the server 435 will deny the reviewer 450 such access. As shown in FIG. 8, a reviewer's permission level may be based on reviewer roles 850. Reviewer roles 850 allow reviewer's 450 having a reviewer account 445 within the system to access user content assigned to the reviewer's 450 reviewer account 445.

To define a set of acceptance criteria 437, an administrator 670 may be required to make a request, via and administrator interface, to the server 435 to define a set of acceptance criteria. To prevent unauthorized individuals from defining acceptance criteria 437, permission to define acceptance criteria 437 may be granted or denied by the server 435 based on the administrator's 670 permission level. If the administrator's 670 permission level is sufficient, the server 435 will allow the administrator 670 to define a set of acceptance criteria 437. Conversely, if the administrator's permission level is insufficient, the server 435 will deny the administrator's 670 request and prevent the administrator 670 from defining acceptance criteria 437. As further shown in FIG. 8, an administrator's 670 permission level may be based on administrator roles 870. Administrator roles 870 may allow administrators 670 to access all data within the system 880, including the user content 830 associated with user accounts 441. Administrator roles 870 also preferably allow administrators 670 to define acceptance criteria 437 and to assign reviewer accounts 445 to review groups.

Although the system and method of the present disclosure has been discussed in relation to the transmission of user content to social media platforms, one of skill in the art will appreciate that the inventive subject matter disclosed herein may be utilized in other fields or for other applications which require content regulation.

The implementations set forth in the foregoing description do not represent all implementations consistent with the subject matter disclosed herein. In stead, they are merely some examples consistent with aspects related to the described subject matter. Although a few variations have been described in detail above, other modifications or additions are possible. In particular, further features and/or variations can be provided in addition to those set forth herein. Fore example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. It will be readily understood to those skilled in the art that various other changes in the details, materials, and arrangements of the parts and method stages that have been described and illustrated in order to explain the nature of this inventive subject matter can be made without departing from the principles and scope of the inventive subject matter.

What is claimed is:

1) A method for regulating the transmission of content, said method comprising the steps of:
creating a user account within a database, the user account having a set of user credentials corresponding to a user tied thereto;
creating one or more reviewer accounts within the database, each reviewer account of the one or more reviewer accounts having a set of reviewer credentials corresponding to a reviewer tied thereto;
generating, by the user via a user interface, user content for submission to a public platform, the user content being associated with the user account corresponding to the user;
transmitting the user content from the user interface to a server;
assigning, by the server, the user content to one or more reviewers;
transmitting, by the server to a reviewer interface, the user content for review;
defining, by the one or more reviewers, a set of context criteria to govern acceptance or rejection of the user content for transmission to the public platform;
analyzing, by the one or more reviewers, the user content to determine whether the user content complies with the set of context criteria;
accepting, by the one or more reviewers, via a reviewer interface, the user content for transmission to the public platform if the user content satisfies the set of context criteria;
rejecting, by the one or more reviewers via the reviewer interface, the user content for transmission to the public platform if the user content does not satisfy the set of context criteria;
defining, by an administrator, a set of acceptance criteria, the set of acceptance criteria relating to the one or more reviewers' acceptance or rejection of the user content;
comparing, by the server, the one or more reviewers' acceptance or rejection of the user content to the set of acceptance criteria to determine a match therebetween;
transmitting, by the server to the public platform, the user content upon the server determining a match between the one or more reviewers' acceptance or rejection of the user content and the set of acceptance criteria; or
blocking, by the server, transmission of the user content to the public platform upon the server determining a non-match between the one or more reviewers' acceptance or rejection of the user content and the set of acceptance criteria.

2) The method of claim 1, wherein the user account is tied to one or more reviewer accounts within the database, and wherein the server assigns the user content to the one or more reviewers based on the one or more reviewer accounts tied to the user account.

3) The method of claim 1, further comprising the step of:
storing, by the server, the user content within the database.

4) The method of claim 1, wherein the public platform is one or more social media platforms, and wherein the set of user credentials comprises one or more social media account credentials, each of the one or more social media account credentials being associated with a social media platform of the one or more social media platforms.

5) The method of claim 4 further comprising the step of:
transmitting, by the server, the one or more social media account credentials to the public platform.

6) The method of claim 1, wherein the user content is assigned to at least two reviewers, and wherein the set of acceptance criteria relates to the number of reviewers required to accept user content.

7) The method of claim 1, wherein the server abstracts metadata from the one or more reviewers' acceptance or rejection of the user content and utilizes the metadata to determine a match between the one or more reviewers' acceptance or rejection of the user content and the set of acceptance criteria.

8) The method of claim 5, wherein the set of acceptance criteria relates to a timestamp of the one or more reviewers' acceptance or rejection of the user content.

9) The method of claim 1, further comprising the steps of:
requesting, by the user via the user interface, permission to transmit the user content to the server, the user's ability to transmit the user content being limited by the user's permission level; and
verifying, by the server, the user's permission level.

10) The method of claim 1, further comprising the steps of:
requesting, by the one or more reviewers via the reviewer interface, access to view the user content assigned to the one or more reviewers, the one or more reviewers' access to the user content being limited by the one or more reviewers' permission level; and
verifying, by the server, the one or more reviewers' permission level.

11) A method for regulating the transmission of content to a public platform, said method comprising the steps of:
providing a private network comprising:
a database;
a user interface;
a reviewer interface;
an administrator interface; and
a server operably connected to the database, the user interface, the reviewer interface, and the administrator interface;
creating a user account within the database,
the user account having a set of user credentials corresponding to a user tied thereto;
creating a plurality of reviewer accounts within the database,
each reviewer account of the plurality of reviewer accounts having a set of reviewer credentials corresponding to a reviewer tied thereto;
generating, by the user via the user interface, user content for submission to a public platform, the user content being associated with the user account corresponding to the user;
defining, by an administrator via the administrator interface, a plurality of review groups within the private network, each review group within the plurality of review groups having a set of context criteria associated therewith governing the acceptance or rejection of user content for transmission to the public platform;
assigning, by the administrator via the administrator interface, each reviewer account within the plurality of reviewer accounts to a review group within the plurality of review groups;
assigning, by the server, the user account to a review group within the plurality of review groups;
assigning, by the server, the user content to one or more reviewer accounts within the plurality of reviewer accounts based on the review group to which the user account is assigned such that the reviewers corresponding to the one or more reviewer accounts assigned to the review group to which the user content is assigned may access the user content;
transmitting, by the server to the reviewer interface, the user content for review;
analyzing, by the reviewers, the user content to determine whether the user content complies with the set of context criteria associated with the reviewers' assigned review group;
accepting, by the reviewers, the user content for transmission to the public platform if the user content satisfies the set of context criteria associated with the reviewers' assigned review group;
rejecting, by the reviewers, the user content for transmission to the public platform if the user content does not satisfy the set of context criteria associated with the reviewers' assigned review group;
defining, by the administrator via the administrator interface, a set of acceptance criteria, the set of acceptance criteria relating to the reviewers' acceptance or rejection of the user content;
comparing, by the server, the reviewers' acceptance or rejection of the user content to the acceptance criteria to determine a match therebetween;
transmitting, by the server to the public platform, the user content upon the server determining a match between the reviewers' acceptance or rejection of the user content and the set of acceptance criteria; or
blocking, by the server, transmission of the user content to the public platform upon the server determining a non-match between the reviewers' acceptance or rejection of the user content and the set of acceptance criteria.

12) The method of claim 11, wherein the user account is assigned to at least two review groups within the plurality of review groups.

13) The method of claim 11, wherein the public platform is one or more social media platforms, and
wherein the set of user credentials comprises one or more social media account credentials, each of the one or more social media account credentials being associated with a social media platform of the one or more social media platforms, and further comprising the step of:
transmitting, by the server, the one or more social media account credentials to the public platform.

14) The method of claim 11, wherein the user content is assigned to at least two reviewer accounts, and wherein the set of acceptance criteria relates to the number of reviewers required to accept the user content.

15) The method of claim 11, wherein the server abstracts metadata from the one or more reviewers' acceptance or rejection of the user content and utilizes the metadata to determine a match between the reviewers' acceptance or rejection of the user content and the acceptance criteria, and where the acceptance criteria relates to a timestamp of the reviewers' acceptance or rejection of the user content.

16) The method of claim 11, further comprising the steps of:
requesting, by the user via the user interface, permission to transmit the user content to the server, the user's ability to transmit the user content being limited by the user's permission level; and
verifying, by the server, the user's permission level.

17) The method of claim 11, further comprising the steps of:
requesting, by the reviewers via the reviewer interface, access to view the user content assigned to the one or more reviewer accounts, the reviewers' access to the user content being limited by the reviewers' permission level; and
verifying, by the server, the reviewers' permission level.

18) The method of claim 11, further comprising the steps of:
requesting, by the administrator via the administrator interface, permission to define acceptance criteria, the administrator's ability to define acceptance criteria being limited by the administrator's permission level; and
verifying, by the server, the administrator's permission level.

19) The method of claim 11, further comprising the steps of:
requesting, by the administrator via the administrator interface, permission to assign each reviewer account within the plurality of reviewer accounts to a review group within the plurality of review groups, the administrator's ability to assign reviewer accounts being limited by the administrator's permission level; and
verifying, by the server, the administrator's permission level.

20) A system for regulating the transmission of content, said system comprising:
a private network comprising:
a database configured to store account credentials and user content therein;
a first computing device configured to display a user interface and to receive and transmit user content inputted into the user interface by a user;
a second computing device configured to display a reviewer interface containing user content and to transmit instructions relating to the acceptance or rejection of user content inputted into the reviewer interface by a reviewer;
a server operably connected to the first computing device, the second computing device, and the database;
a non-transitory computer readable medium coupled to the server having programming instructions stored thereon, which, when executed by the server cause the server to perform operations comprising:
receiving the user content transmitted by the first computing device;
storing user content within the database;
transmitting the user content to the second computing device such that reviewers having a sufficient permission level may access and review the user content via the reviewer interface;
receiving reviewer instructions transmitted from the second computing device;
receiving a set of acceptance criteria inputted by an administrator via an administrator interface;
comparing reviewer instructions received from the second computing device to the set of acceptance criteria to determine a match therebetween;
transmitting the user content upon determining a match between the reviewer instructions received from the second computing device and the set of acceptance criteria; or
blocking transmission of the user content upon determining a non-match between the reviewer instructions received from the second computing device and the acceptance criteria; and
a public platform configured to receive the user content transmitted from the server of the private network.
